(19) United States
(12) Patent Application Publication
(10) Pub. No.: US 2009/0112604 A1
(43) Pub. Date: Apr. 30, 2009

(54) Automatically Generating Interactive Learning Applications

(76) Inventors: Karl W. Scholz, Strafford, PA (US); David Topolewski, Los Angeles, CA (US); Hong Mu, Alhambra, CA (US)

Correspondence Address: COURTNEY STANIFORD & GREGORY LLP, P.O. BOX 9686, SAN JOSE, CA, 95157, US

(21) Appl. No.: 12/258,080

(22) Filed: Oct. 24, 2008

Related U.S. Application Data
(60) Provisional application No. 60/982,248, filed on Oct. 24, 2007.

(51) Int. Cl. G10L 21/00

(52) U.S. Cl. 704/275; 704/E15.001

(57) ABSTRACT

Systems and methods are described for generating an interactive voice response (IVR) application from a state transition table and set of extensible markup language templates. Embodiments include representing an interactive student-computer dialog as a state transition table. The target interactive voice and video response (IVVR) markup language is encoded as a discrete set of extensible templates. The dialog states are mapped to IVVR markup language by selecting appropriate extensible templates and instantiating parameterized elements of each template with dialog state constituents. Embodiments organize the extended templates coherently and package the extended templates for deployment on an IVVR delivery platform.

### RELATED APPLICATION

This application claims the benefit of U.S. Patent Application No. 60/982,248, filed Oct. 24, 2007.

### TECHNICAL FIELD

The present invention relates to the field of interactive learning via network-based devices, including, more particularly, automatically generating interactive learning applications for distribution via a network.

### BACKGROUND

Experience has shown that interactive learning tools, for example instructional videos or presentations delivered via a public network (e.g., the Internet, 3G telephone network, etc.), can be highly effective vehicles for targeting individuals with learning needs. For example, a variety of subjects with wide appeal such as lessons for teaching English as a Second Language (ESL), are easily disseminated via the Internet and mobile devices or computers. However, the process by which new lessons are developed and deployed via these networks entails significant dedication of time by highly trained authors, artists, software engineers, and other professionals, and this can limit the availability of such learning tools. Consequently, there is a need for systems and methods that reduce the time and costs required to design and deploy lessons by automating the work required to generate interactive learning applications for dissemination via networks and/or mobile devices.

### INCORPORATION BY REFERENCE

Each patent, patent application, and/or publication mentioned in this specification is herein incorporated by reference in its entirety to the same extent as if each individual patent, patent application, and/or publication was specifically and individually indicated to be incorporated by reference.

### BRIEF DESCRIPTION OF THE DRAWINGS

FIG. 1 shows lesson development and delivery, under an embodiment.

FIG. 2 is an example of a state transition table, under an embodiment.

FIG. 3 is a flow diagram for audio and video generation and integration into an interactive learning application, under an embodiment.

FIG. 4 is a flow diagram for template processing, under an embodiment.

FIG. 5 is a flow diagram for extensible template processing, under an embodiment.

FIG. 6 shows interaction modes and the corresponding templates, under an embodiment.

FIG. 7 is an example list of lesson metadata elements which are used to define lesson characteristics and ancillary requirements for each lesson, and to provide search targets for future database searches in an extensively populated lesson repository, under an embodiment.

### DETAILED DESCRIPTION

Methods and systems are described below for automatically generating interactive learning applications for deploying via networks and/or mobile or fixed devices. An instructional lesson of an embodiment comprises a dialog between a student and a computer mediated by a presentation device configured to produce full-motion color images synchronized with sound, and input devices comprising one or more of a microphone, a pointing device, and a keyboard with multiple keys. Output to the student comprises didactic material formatted as video vignettes intended to engage and inform the student. Input to the computer comprises spoken words or phrases, positioning an on-screen cursor using a pointing device, and/or entering commands or alphanumeric data by pressing keys.

In the following description, numerous specific details are introduced to provide a thorough understanding of, and enabling description for, the embodiments described herein. One skilled in the relevant art, however, will recognize that these embodiments can be practiced without one or more of the specific details, or with other components, systems, etc. In other instances, well-known structures or operations are not shown, or are not described in detail, to avoid obscuring aspects of the disclosed embodiments.

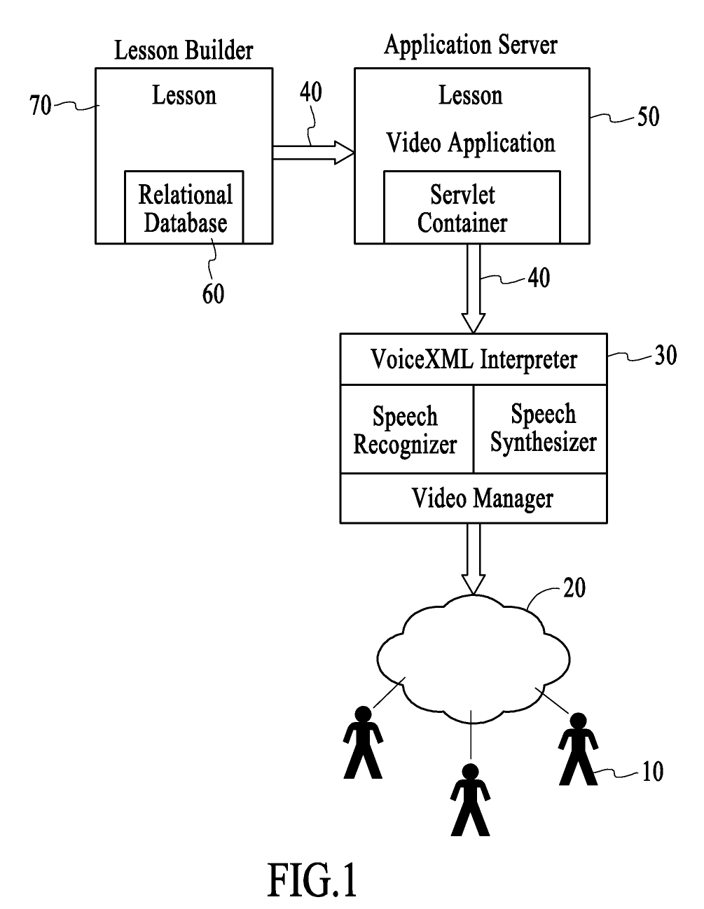

FIG. 1 shows the lesson development and delivery environment, under an embodiment. The IVVR (Interactive Voice and Video Response) delivery platform 30 of an embodiment comprises a Voice Extensible Markup Language (VoiceXML) interpreter, a speech recognizer, a speech synthesizer, and a video manager, but is not limited to these components. A lesson 70 is generated or constructed as a video-mediated dialog using the Lesson Builder application 60, packaged, and delivered through a network 40 (e.g., local area network (LAN), wide area network (WAN), etc.) to the application server 50. The servlet container in the application server 50 is configured to control or manage the delivery process by which the video application in VoiceXML is delivered through network 40 to the IVVR delivery platform 30. End users (e.g., students) 10 interact with a learning application via the IVVR delivery platform 30 and a network 20 coupling or connection (e.g., public network, telephone network, communication network, etc.).

Lessons of an embodiment are structured as a network of dialog states, where each dialog state comprises an audio-video presentation or ‘prompt’, a set of possible responses a student will make when that prompt is displayed, and a set of contingencies wherein each possible response is mapped to some action. A lesson of an embodiment is represented using a state table, also referred to herein as a state transition table. The representation of a lesson in the state table is facilitated by giving each dialog state a name by which it can be referred. A conversation can then be conceived of as a directed graph and can be readily captured as a state transition table.

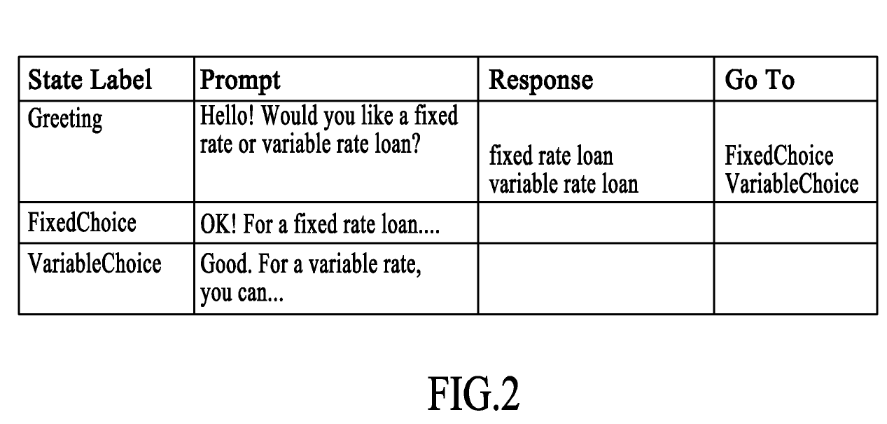

FIG. 2 is an example of a state transition table, under an embodiment. The state transition table of this example includes numerous dialog state fields including, but not limited to, a state label field, prompt field, response field, and go to field. While the state transition table of this example shows only a fragment of a complete dialog, it shows that details of a dialog can be fully represented using a tabular spreadsheet format.

The methods and systems described herein for automatically generating interactive learning applications are configured to accept as input an instructional dialog formatted as a tabular spread-sheet, as described above, and to output an application packaged for deployment on a commercial Interactive Voice and Video Response (IVVR) platform. Automatic production or generation of the interactive learning application of an embodiment begins by naming the lesson and specifying default prompts and display modes. The lesson author populates a state transition table with all required prompts and responses. The dialog flow of the lesson is simulated for the author to review and correct. The interactive learning application is generated using synthesized audio prompts, and deployed for review by the author and selected testers. A spreadsheet is generated listing or including all required audio prompts with filenames assigned for each audio prompt. Audio is recorded for all prompts, and artists define avatars and annotate the spreadsheet to manage video generation, and video prompts are produced. The interactive learning application is then generated in a video mode, incorporating all video prompts.

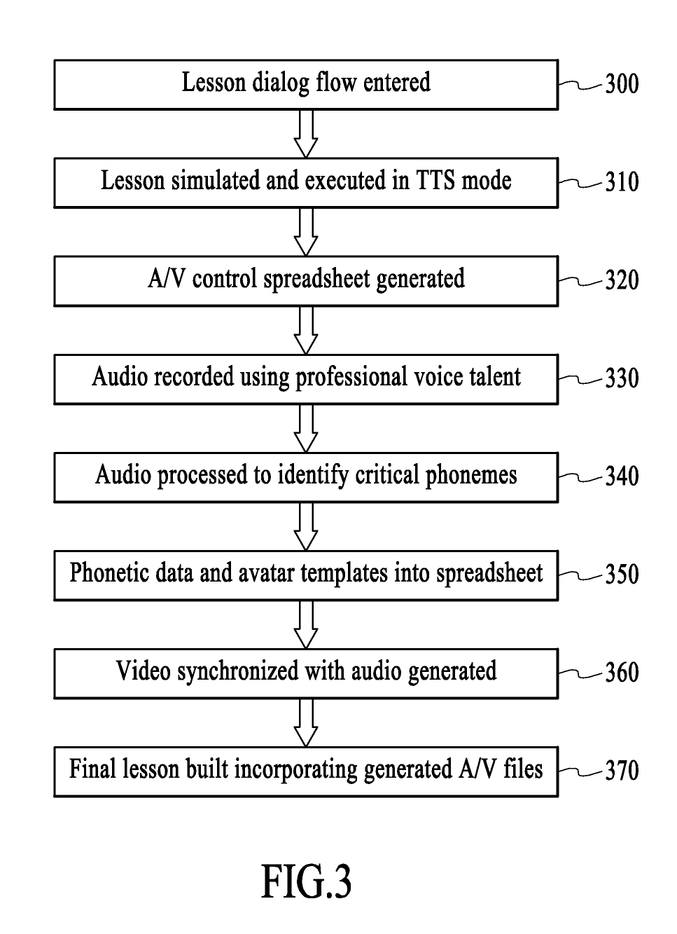

FIG. 3 is a flow diagram for audio and video generation and integration into an interactive learning application, under an embodiment. The interactive learning application is generated, as described above, using synthesized audio prompts, and deployed for review by the author and selected testers. A spreadsheet is generated listing or including all required audio prompts with filenames assigned for each audio prompt. Audio is recorded for all prompts, and artists define avatars and annotate the spreadsheet to manage video generation, and video prompts are produced. The interactive learning application is then generated in a video mode, incorporating all video prompts.

To generate the audio and video for a lesson, operation begins when the lesson author enters the dialog flow 300 including the text for all prompts and responses. The lesson is then simulated and/or executed in text-to-speech (TTS) mode 310 in order to validate the dialog call flow. An audio/video control spreadsheet 320 is then generated which includes all prompt, response, and navigation text, with each being assigned a unique filename. Commercial or other voice talent is then used to record all the text and assign each to a unique file 330. A speech recognition application is then used to process each recording to identify critical phonemes and position each on the recording's timeline 340. This data along with avatar identification data is added to the spreadsheet 350. Video synchronized with audio is then generated 360. The resulting audio files are then converted into the necessary format for play and/or display through the telephone network, moved to directories visible to the generation tool, and integrated into a completed lesson 370.

Generation of the IVVR application and the prompt management spreadsheet of an embodiment represent a unique application of software methodology within the telephone-delivered interactive learning field and, in so doing, extends the lesson specification process to a large community of developers using a public network (e.g., the internet). The interactive learning application generation of an embodiment generally includes the use of “templates”, where a template precisely reflects the dialog flow of a lesson, but is devoid of textual content. The web-based lesson creation tool of an embodiment provides secure access to templates to writers who are able to insert prompts and anticipated responses into each turn of the template, but are unable to alter the template's dialog flow structure. Lesson writers are able to simulate the execution of a lesson derived from a populated template by viewing each turn interactively, seeing and hearing its prompt and list of anticipated responses, then choosing a response which causes the simulator to advance to the corresponding turn.

Lessons generated by a community of writers instructed on template completion are subjected to quality assurance testing to ensure the lessons comply with corporate standards. Following successful quality assurance testing, the lessons are deployed as interactive video-based lessons as described herein. Administrative procedures assess the popularity of all such lessons in the student community, and lesson writers for lessons achieving significant popularity may be rewarded a share of the lesson's revenue.

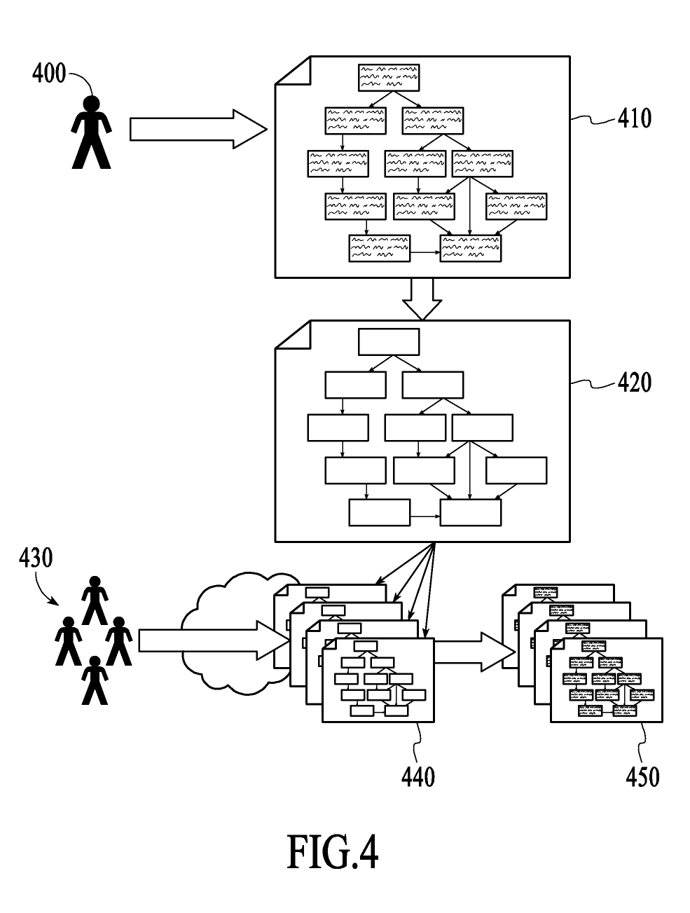

FIG. 4 is a flow diagram for template processing, under an embodiment. Template processing begins when the lesson designer 400 generates and populates a lesson 410. The lesson is prepared as a template 420 which retains the dialog flow but is devoid of content. A community of lesson writers 430 is then given access through the public network (e.g., internet) to individual copies of the template 440 which they then populate with material (e.g., text, graphics, etc.) to create completed lessons 450. These lessons are then deployed as described above.

Once lesson authors or writers complete the specification of a lesson as a state transition table, the lesson is rendered as VoiceXML (Voice Extensible Markup Language) for disposition on a commercial IVVR platform for access by students through the telephone network. A method of an embodiment for VoiceXML generation includes converting extensible markup language templates into executable VoiceXML documents by replacing flagged parameters in each template with values from the newly-created lesson database.

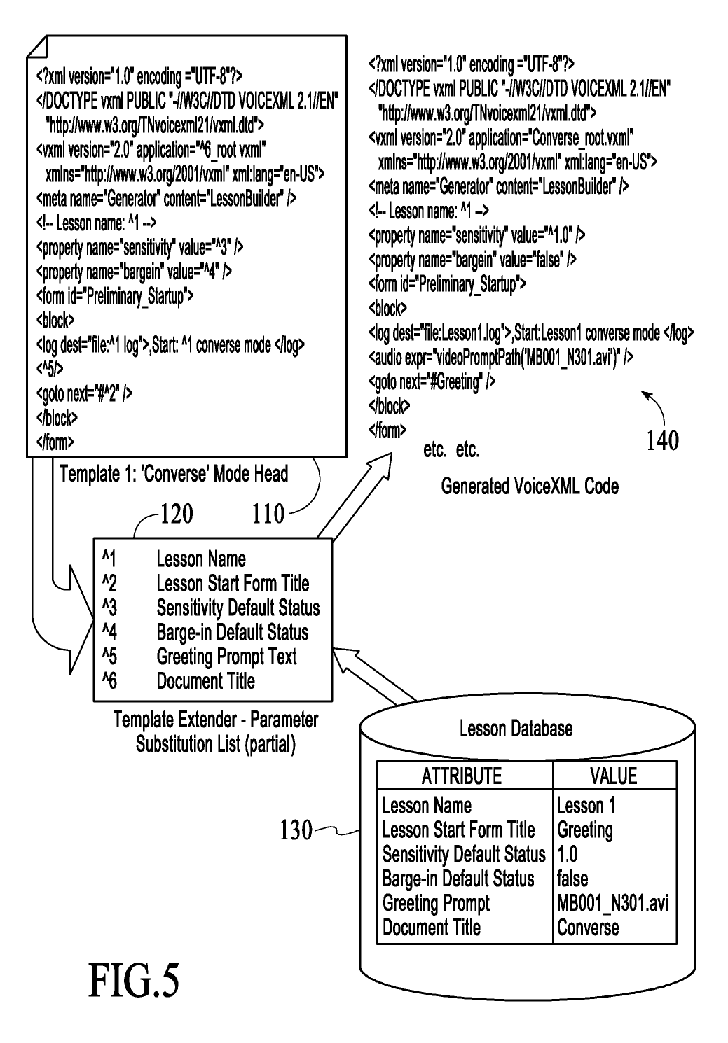

FIG. 5 is a flow diagram for extensible markup language template processing, under an embodiment. As described above, a markup language template contains syntactically valid markup language, except selected parameters or “extension points” are marked for substitution by a caret (‘̂’) followed by an index. A template 110 of an embodiment is processed by a Template Extender 120 using the values for each required attribute obtained from the Lesson Database 130 to substitute for each extension point in template 110. The resulting extended template is emitted as generated VoiceXML document 140.

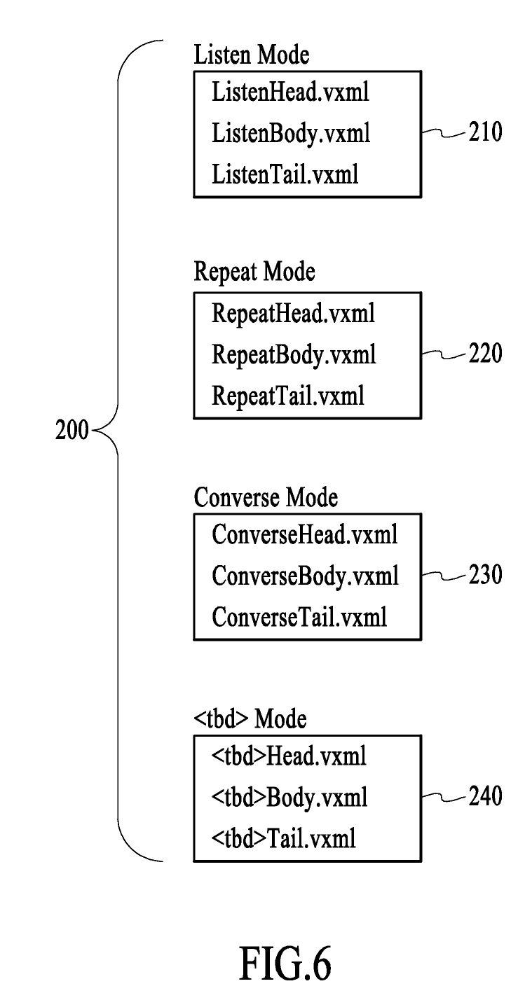

FIG. 6 shows interaction modes and the corresponding markup language templates, under an embodiment. The interaction modes, also referred to as lesson dialog modes 200, include a listen mode, repeat mode, converse mode, and any number or type of other modes. The listen mode 210 of an embodiment comprises playing all prompts and responses in a lesson to a student with no requirement for student input. The repeat mode 220 of an embodiment comprises playing each prompt and each possible response to a student who must in turn verbally repeat what was played. The converse mode 230 of an embodiment comprises playing each prompt and the student must in turn say the appropriate response. Each interaction mode of an embodiment is implemented using three extensible templates whose extension points are instantiated with values from the lesson database. The mode specification process is extensible 240 by users of the Lesson Builder application.

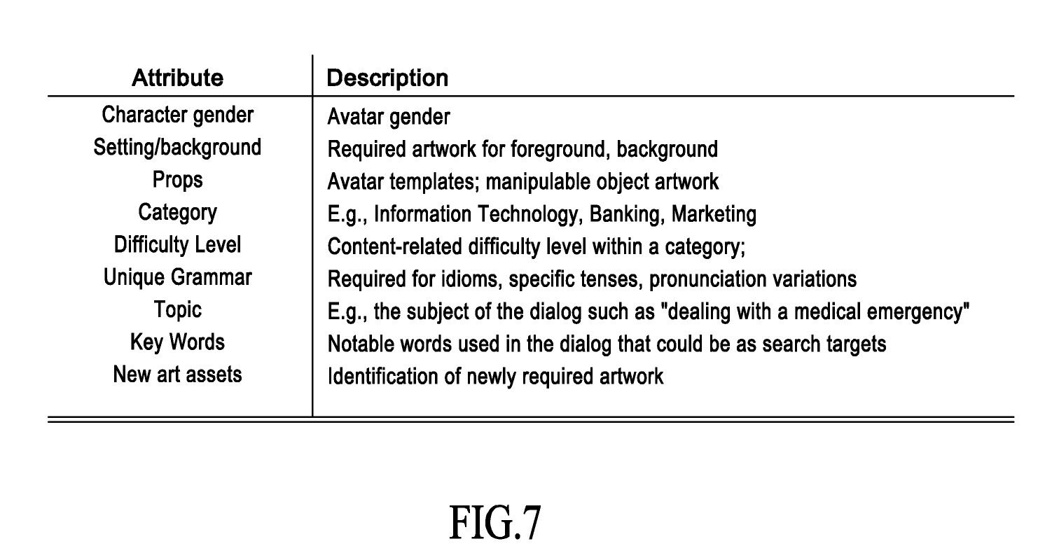

FIG. 7 is an example list of lesson metadata elements which are used to define lesson characteristics and ancillary requirements for each lesson, and to provide search targets for future database searches in an extensively populated lesson repository, under an embodiment. Lesson metadata is also used at runtime to annotate and catalog analytic data. The analytics serve as the core vehicle for performance analysis and process improvement.

The systems and methods described herein include a method for generating an interactive voice response application from a state transition table and set of extensible markup language templates. The method of an embodiment comprises representing an interactive student-computer dialog as a state transition table. The method of an embodiment comprises encoding the target IVVR markup language as a discrete set of extensible templates. The method of an embodiment comprises mapping dialog states to IVVR markup language by selecting appropriate extensible templates and instantiating parameterized elements of each template with dialog state constituents. The method of an embodiment comprises organizing the extended templates coherently and packaging for deployment on an IVVR delivery platform.

The systems and methods described herein include a method for the dynamic specification of learning modes. The method of an embodiment comprises a structure for managing the set of IVVR markup language extensible templates used to implement a mode. The method of an embodiment comprises producing an IVVR markup language application that implements the specified mode. The systems and methods described herein include a method for generating an interactive voice response application from a state transition table and set of extensible markup language templates. The method of an embodiment comprises representing an interactive student-computer dialog as a state transition table. The method of an embodiment comprises encoding the target IVVR markup language as a discrete set of extensible templates. The method of an embodiment comprises mapping dialog states to IVVR markup language by selecting appropriate extensible templates and instantiating parameterized elements of each template with dialog state constituents. The method of an embodiment comprises organizing the extended templates coherently and packaging for deployment on an IVVR delivery platform.

The systems and methods of an embodiment include a method for the automatic generation of speech recognition context-free grammars from a dialog state table and set of extensible grammar templates. The method of an embodiment comprises representing an interactive student-computer dialog as a dialog state table. The method of an embodiment comprises encoding the context-free grammars as a discrete set of extensible templates. The method of an embodiment comprises mapping dialog states to context-free grammars by selecting appropriate extensible grammar templates and instantiating parameterized elements of each template with dialog state constituents. The method of an embodiment comprises organizing the extended templates into complete context-free grammars and packaging them for deployment on an IVVR delivery platform.

The systems and methods described herein include a structured methodology for managing new lesson evaluation. The method of an embodiment comprises simulating a lesson's dialog flow using a conventional web browser as the interaction device. The method of an embodiment comprises deploying a functionally complete lesson prior to the creation of audio or video prompts. The method of an embodiment comprises generating a spreadsheet listing all prompts and responses in an application, each associated with a generated filename to be used for commercially-recorded audio and video files.

The systems and methods described herein include a method for generating subtitled videos to assist students in mastering essential rote memorization. A student can enable or disable the display of subtitles on a video display at any time with a single keystroke.

The systems and methods described herein include a method for representing a portion or all components of a lesson in a relational database. The method of an embodiment comprises a database schema defining the collection of tables and columns in each table with which a lesson can be uniquely represented. The method of an embodiment comprises a collection of structured query language (SQL) tables with which all information required by a lesson can be stored and retrieved. The method of an embodiment comprises a collection of administration management scripts with which lesson database elements can be created, deleted, renamed, and copied.

The systems and methods described herein include a method for automatically generating navigation control dialog. The method of an embodiment comprises a method for defining a dialog with a student wherein the student is prompted to verbally identify any available dialog mode to which the system responds by invoking the requested dialog mode (e.g., listen, repeat, converse). The method of an embodiment comprises a method for generating a coherent assistance prompt presented in response to a student's query seeking a list of all available modes.

The systems and methods described herein include a method for permitting lesson authors complete access to all lesson creation functionality using the public Internet and standard web browsers. The systems of an embodiment include a graphical user interface (GUI) configured to allow lesson authors or administrators to initialize a new lesson. The GUI of an embodiment is configured to allow lesson authors to specify all environmental attributes, display modes, dialog interaction modes, prompts, and anticipated responses to a lesson. The GUI of an embodiment is configured to offer or present to lesson writers a “lesson template” wherein only the text comprising prompts and responses need be entered to fully define a lesson. The GUI of an embodiment is configured to allow a lesson to be simulated. The lesson simulation of an embodiment displays the prompt and response alternatives for each dialog turn, and the author need only click on the selected response alternative to simulate a student's verbal response.

The systems and methods described herein include a method for generating lesson templates which precisely reflect the dialog structure of a lesson but which are devoid of textual content. The method of an embodiment comprises a method of limiting access to the lesson construction environment such that a lesson writer can access only the unspecified textual fields of a template but is prevented from altering the dialog structure of the lesson. The method of an embodiment comprises a method to ensure all unspecified textual fields of a template are fully specified by the writer. The method of an embodiment comprises simulating the execution of a lesson derived from a fully populated template by sequentially outputting the prompt and a corresponding list of anticipated responses for each turn. The method of an embodiment comprises awaiting the user's selection of a response and transitioning to the dialog turn appropriate to the selected response. The method of an embodiment comprises restricting individual lesson author access to specific templates with security sufficient to accommodate a community of writers contributing to lesson development over a public network.

The method of an embodiment comprises applying quality assurance (QA) procedures to lessons to ensure lessons contributed by a community of writers each meet or exceed pre-established quality standards. The method of an embodiment comprises rewarding a writer who generates a lesson that achieves popularity with the student community by sharing with the writer a portion of the revenue generated by his/her lesson. Writers and development managers contribute to the creation of lesson metadata as illustrated in FIG. 7 herein, which is used both to define activities required in each lesson development step and to facilitate search for lessons or lesson elements in a growing lesson repository.

The systems and methods described herein include workflow management methods for sequencing the lesson development process and packaging complete lessons for delivery and deployment. Workflow management ensures that each essential procedural step required to generate and publish a lesson is completed and tracked. If elements of a lesson fail to meet or exceed a quality standard at any step, they are flagged to facilitate their easy correction, and the lesson is barred from moving to subsequent workflow steps. Workflow management includes facilities for generating audio recording scripts, annotating speaker affect to control avatar lip synchronization, generating video both with and without subtitles, and packaging and compressing all components of a lesson into a single Web ARchive (WAR) file. The packaging and delivering of a lesson of an embodiment comprises downloading the packaged lesson to the developer's workstation for subsequent disposition to an IVVR delivery environment.

Embodiments described herein include a method comprising: representing an interactive student-computer dialog as a dialog state table; encoding a target interactive voice response (IVR) markup language as a discrete set of extensible markup language templates; mapping dialog states of the dialog state table to the IVR markup language by selecting extensible markup language templates of the discrete set; instantiating parameterized elements of each extensible markup language template with dialog state constituents; and generating an IVR application from the dialog state table by organizing the extensible markup language templates for deployment on an IVR delivery platform.

Embodiments described herein include a method comprising: representing an interactive student-computer dialog as a dialog state table; encoding context-free grammars as a discrete set of extensible markup language templates, the context-free grammars comprising speech recognition context-free grammars; mapping dialog states of the dialog state table to the context-free grammars by selecting extensible markup language templates of the discrete set; instantiating parameterized elements of each extensible markup language template with dialog state constituents; and automatically generating speech recognition context-free grammars from the dialog state table and set of extensible grammar templates by organizing the extensible markup language templates into complete context-free grammars and packaging them for deployment on an interactive voice response (IVR) delivery platform.

Embodiments described herein include a system comprising: a user interface coupled to a processor; and a lesson builder coupled to the processor, the lesson builder including a lesson template corresponding to a lesson, the lesson template including a dialog structure and unspecified textual fields, wherein the dialog structure is locked, the lesson builder receiving an entry for each unspecified textual field via the user interface and generating a completed template, the lesson builder generating the lesson from the completed template and simulating execution of the lesson by sequentially outputting each dialog turn of the lesson by outputting a prompt of each dialog turn and a corresponding list of anticipated responses for the prompt, receiving a response to each prompt, the response selected by a user, and advancing to a next dialog turn, the next dialog turn corresponding to the response received.

The lesson builder of an embodiment performs quality assurance testing on the lesson and generates the lesson by revising the lesson in response to results of at least one of the simulating and the quality assurance testing.

The system of an embodiment comprises a deployment platform coupled to the lesson builder and to the user interface, wherein the lesson is deployed via the user interface to a user as an interactive lesson.

The system of an embodiment comprises a database coupled to the processor, the database including a collection of tables and columns in each table with which the lesson is uniquely represented.

Embodiments described herein include a system comprising: a user interface coupled to a processor; a lesson builder coupled to the processor, the lesson builder including a lesson template corresponding to a lesson, the lesson template including a dialog structure and unspecified textual fields, the lesson builder receiving an entry for each unspecified textual field and automatically generating a completed template, the lesson builder generating the lesson from the completed template and simulating execution of the lesson by sequentially outputting each dialog turn of the lesson; and a deployment platform coupled to the lesson builder and to the user interface, wherein the lesson is deployed via the user interface to a user as an interactive lesson.

Embodiments described herein include a method comprising: providing a lesson template corresponding to a lesson, the lesson template including a dialog structure and unspecified textual fields, wherein the dialog structure is locked; receiving an entry for each unspecified textual field via a user interface and generating a completed template; generating a draft lesson from the completed template; and simulating execution of the draft lesson by sequentially outputting each dialog turn of the lesson by outputting a prompt of each dialog turn and a corresponding list of anticipated responses for the prompt, receiving a response to each prompt, the response selected by a user, and advancing to a next dialog turn, the next dialog turn corresponding to the response received.

Generating a draft lesson of an embodiment comprises receiving specification of environmental attributes, display modes, dialog interaction modes, prompts, and anticipated responses.

The method of an embodiment comprises performing quality assurance testing on the draft lesson. The method of an embodiment comprises generating a final lesson by revising the lesson in response to results of at least one of the simulating and the quality assurance testing.

The method of an embodiment comprises deploying the final lesson as an interactive lesson via a public communication network.

The deploying of an embodiment comprises packaging and delivering the final lesson, wherein all components of the final lesson are packaged and compressed into a single Web ARchive (WAR) file and downloaded to a remote workstation for subsequent disposition to an interactive voice response (IVR) delivery environment.

The method of an embodiment comprises rewarding a writer of the final lesson, the rewarding comprising a portion of the revenue generated by the final lesson.

The method of an embodiment comprises providing the lesson template via a network coupling.

Providing the lesson template comprises providing restricted access to the lesson template by a plurality of lesson writers via a network coupling.

A database schema of an embodiment defines a collection of tables and columns in each table with which the final lesson is uniquely represented.

All information required by the final lesson of an embodiment is stored and retrieved using a collection of structured query language (SQL) queries.

Lesson database elements of an embodiment are created, deleted, renamed, and copied using a collection of administration management scripts.

The method of an embodiment comprises simulating a dialog flow of the draft lesson via an interaction device that includes a web browser.

The method of an embodiment comprises deploying a functionally complete draft lesson prior to creation of at least one of audio prompts and video prompts.

The systems and methods described herein include and/or run under and/or in association with a processing system. The processing system includes any collection of processor-based devices or computing devices operating together, or components of processing systems or devices, as is known in the art. For example, the processing system can include one or more of a portable computer, portable communication device operating in a communication network, and/or a network server. The portable computer can be any of a number and/or combination of devices selected from among personal computers, mobile telephones, personal digital assistants, portable computing devices, and portable communication devices, but is not so limited. The processing system can include components within a larger computer system.

The processing system of an embodiment includes at least one processor and at least one memory device or subsystem. The processing system can also include or be coupled to at least one database. The term “processor” as generally used herein refers to any logic processing unit, such as one or more central processing units (CPUs), digital signal processors (DSPs), application-specific integrated circuits (ASIC), etc. The processor and memory can be monolithically integrated onto a single chip, distributed among a number of chips or components, and/or provided by some combination of algorithms. The methods described herein can be implemented in one or more of software algorithm(s), programs, firmware, hardware, components, circuitry, in any combination.

Components of the systems and methods described herein can be located together or in separate locations. Communication paths couple the components and include any medium for communicating or transferring files among the components. The communication paths include wireless connections, wired connections, and hybrid wireless/wired connections. The communication paths also include couplings or connections to networks including local area networks (LANs), metropolitan area networks (MANs), wide area networks (WANs), proprietary networks, interoffice or backend networks, and the Internet. Furthermore, the communication paths include removable fixed mediums like floppy disks, hard disk drives, and CD-ROM disks, as well as flash RAM, Universal Serial Bus (USB) connections, RS-232 connections, telephone lines, buses, and electronic mail messages.

Unless the context clearly requires otherwise, throughout the description, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import refer to this application as a whole and not to any particular portions of this application. When the word “or” is used in reference to a list of two or more items, that word covers all of the following interpretations of the word: any of the items in the list, all of the items in the list and any combination of the items in the list.

The above description of embodiments of the systems and methods described herein is not intended to be exhaustive or to limit the systems and methods described to the precise form disclosed. While specific embodiments of, and examples for, the systems and methods described herein are described herein for illustrative purposes, various equivalent modifications are possible within the scope of other systems and methods, as those skilled in the relevant art will recognize. The teachings of the systems and methods described herein provided herein can be applied to other processing systems and methods, not only for the systems and methods described above.

The elements and acts of the various embodiments described above can be combined to provide further embodiments. These and other changes can be made to the systems and methods described herein in light of the above detailed description.

In general, in the following claims, the terms used should not be construed to limit the embodiments to the specific embodiments disclosed in the specification and the claims, but should be construed to include all systems that operate under the claims. Accordingly, the embodiments are not limited by the disclosure, but instead the scope of the embodiments is to be determined entirely by the claims.

While certain aspects of the embodiments are presented below in certain claim forms, the inventors contemplate the various aspects of the embodiments in any number of claim forms. Accordingly, the inventors reserve the right to add additional claims after filing the application to pursue such additional claim forms for other aspects of the embodiments described herein.

What is claimed is:

1. A method comprising:
representing an interactive student-computer dialog as a dialog state table;
encoding a target interactive voice response (IVR) markup language as a discrete set of extensible markup language templates;
mapping dialog states of the dialog state table to the IVR markup language by selecting extensible markup language templates of the discrete set;
instantiating parameterized elements of each extensible markup language template with dialog state constituents; and
generating an IVR application from the dialog state table by organizing the extensible markup language templates for deployment on an IVR delivery platform.

2. A method comprising:
representing an interactive student-computer dialog as a dialog state table;
encoding context-free grammars as a discrete set of extensible markup language templates, the context-free grammars comprising speech recognition context-free grammars;
mapping dialog states of the dialog state table to the context-free grammars by selecting extensible markup language templates of the discrete set;
instantiating parameterized elements of each extensible markup language template with dialog state constituents; and
automatically generating speech recognition context-free grammars from the dialog state table and set of extensible grammar templates by organizing the extensible markup language templates into complete context-free grammars and packaging them for deployment on an interactive voice response (IVR) delivery platform.

3. A system comprising:
a user interface coupled to a processor; and
a lesson builder coupled to the processor, the lesson builder including a lesson template corresponding to a lesson, the lesson template including a dialog structure and unspecified textual fields, wherein the dialog structure is locked, the lesson builder receiving an entry for each unspecified textual field via the user interface and generating a completed template, the lesson builder generating the lesson from the completed template and simulating execution of the lesson by sequentially outputting each dialog turn of the lesson by outputting a prompt of each dialog turn and a corresponding list of anticipated responses for the prompt, receiving a response to each prompt, the response selected by a user, and advancing to a next dialog turn, the next dialog turn corresponding to the response received.

4. The system of claim 3, wherein the lesson builder performs quality assurance testing on the lesson and generates the lesson by revising the lesson in response to results of at least one of the simulating and the quality assurance testing.

5. The system of claim 4, comprising a deployment platform coupled to the lesson builder and to the user interface, wherein the lesson is deployed via the user interface to a user as an interactive lesson.

6. The system of claim 4, comprising a database coupled to the processor, the database including a collection of tables and columns in each table with which the lesson is uniquely represented.

7. A system comprising:
a user interface coupled to a processor;
a lesson builder coupled to the processor, the lesson builder including a lesson template corresponding to a lesson, the lesson template including a dialog structure and unspecified textual fields, the lesson builder receiving an entry for each unspecified textual field and automatically generating a completed template, the lesson builder generating the lesson from the completed template and simulating execution of the lesson by sequentially outputting each dialog turn of the lesson; and
a deployment platform coupled to the lesson builder and to the user interface, wherein the lesson is deployed via the user interface to a user as an interactive lesson.

8. A method comprising:
providing a lesson template corresponding to a lesson, the lesson template including a dialog structure and unspecified textual fields, wherein the dialog structure is locked;
receiving an entry for each unspecified textual field via a user interface and generating a completed template;
generating a draft lesson from the completed template; and
simulating execution of the draft lesson by sequentially outputting each dialog turn of the lesson by outputting a prompt of each dialog turn and a corresponding list of anticipated responses for the prompt, receiving a response to each prompt, the response selected by a user, and advancing to a next dialog turn, the next dialog turn corresponding to the response received.

9. The method of claim 8, wherein generating a draft lesson comprises receiving specification of environmental attributes, display modes, dialog interaction modes, prompts, and anticipated responses.

10. The method of claim 8, comprising:
performing quality assurance testing on the draft lesson; and
generating a final lesson by revising the lesson in response to results of at least one of the simulating and the quality assurance testing.

11. The method of claim 10, comprising deploying the final lesson as an interactive lesson via a public communication network.

12. The method of claim 11, wherein the deploying comprises packaging and delivering the final lesson, wherein all components of the final lesson are packaged and compressed into a single Web ARchive (WAR) file and downloaded to a remote workstation for subsequent disposition to an interactive voice response (IVR) delivery environment.

13. The method of claim 11, comprising rewarding a writer of the final lesson, the rewarding comprising a portion of the revenue generated by the final lesson.

14. The method of claim 8, comprising providing the lesson template via a network coupling.

15. The method of claim 8, wherein providing the lesson template comprises providing restricted access to the lesson template by a plurality of lesson writers via a network coupling.

16. The method of claim 8, wherein a database schema defines a collection of tables and columns in each table with which the final lesson is uniquely represented.

17. The method of claim 8, wherein all information required by the final lesson is stored and retrieved using a collection of structured query language (SQL) queries.

18. The method of claim 8, wherein lesson database elements are created, deleted, renamed, and copied using a collection of administration management scripts.

19. The method of claim 8, comprising simulating a dialog flow of the draft lesson via an interaction device that includes a web browser.

20. The method of claim 8, comprising deploying a functionally complete draft lesson prior to creation of at least one of audio prompts and video prompts.
